(19) United States
(12) Patent Application Publication
(10) Pub. No.: US 2025/0273036 A1
(43) Pub. Date: Aug. 28, 2025

(54) GAMING SYSTEM AND METHOD WITH A CATALYST-DRIVEN MODIFIER FEATURE

(71) Applicant: LNW Gaming, Inc., Las Vegas, NV (US)

(72) Inventors: Qin YOU, Randwick (AU); Yanhua YIN, Newington (AU)

(21) Appl. No.: 19/050,257

(22) Filed: Feb. 11, 2025

Related U.S. Application Data
(60) Provisional application No. 63/556,655, filed on Feb. 22, 2024.

(51) Int. Cl. G07F 17/32

(52) U.S. Cl. CPC G07F 17/3213; G07F 17/3258; G07F 17/3267

(57) ABSTRACT

There are provided a gaming machine and method that utilize game-logic circuitry and a graphical user interface configured to present a plurality of symbol-bearing reels, an array and a modifier. The symbols include base symbols, value-bearing symbols and at least one catalyst symbol. The value-bearing symbols may bear credit amounts or be associated with a progressive or non-progressive jackpot. The reels are animated to spin and land symbols from the reels in the array. Winning combinations of the base symbols are paid according to a paytable. If the landed symbols include a catalyst symbol but no value-bearing symbols, the modifier is changed. If the landed symbols include value-bearing symbols and a catalyst symbol, an award based on values borne by the landed value-bearing symbols is modified by the modifier and presented. The modifier is then set to a reset value.

### CROSS-REFERENCE TO RELATED APPLICATIONS

This application claims the benefit of priority to U.S. Provisional Application No. 63/556,655, filed Feb. 22, 2024, the contents of which are hereby incorporated by reference in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records but otherwise reserves all copyright rights whatsoever. Copyright 2024-2025, LNW Gaming, Inc.

### FIELD OF THE INVENTION

The present invention relates to a technological improvement to gaming systems, gaming machines, and methods and, more particularly, to technological improvements in connection with a catalyst-driven modifier feature.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple game features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Players may gravitate to a game simply because it offers something they have not seen before in the hope that the new game offers a better chance to win. Thus, improved animations represent improvements to the underlying technology or technical field of gaming apparatus and, at the same time, have the effect of encouraging prolonged and frequent player participation.

### SUMMARY OF THE INVENTION

There are provided a gaming machine and method that utilize game-logic circuitry and a presentation assembly configured to present, via a graphical user interface, a plurality of symbol-bearing reels, an array, and a modifier. The symbols include base symbols, value-bearing symbols and at least one catalyst symbol. The value-bearing symbols may bear credit amounts or be associated with a progressive or non-progressive jackpot. The reels are animated to spin and land symbols from the reels in the array. In response to the landed symbols including no catalyst symbols, awards for winning combinations of the base symbols are paid according to a paytable. In response to the landed symbols including value-bearing symbols and no catalyst symbol, the value-bearing symbols are ignored. In response to the landed symbols including a catalyst symbol but no value-bearing symbols, the modifier is changed. In response to the landed symbols including value-bearing symbols and a catalyst symbol, an award based on values borne by the landed value bearing symbols is modified by the modifier and presented. The modifier is then set to a reset value.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a front view of a free-standing gaming machine according to an embodiment of the present invention.

FIG. 2 is a block diagram of a gaming system according to an embodiment of the present invention.

FIGS. 3A and 3B are a flow diagram for a data processing method that corresponds to instructions executed by a controller according to an embodiment of the present invention. FIG. 3A relates to an initial spin portion of a wagering game; FIG. 3B relates to the triggering of award enhancements in response to the presence of a catalyst symbol.

FIG. 4 is an exemplary presentation of a first scenario resulting from an animated game spin in accordance with one of more embodiments.

FIG. 5 is an exemplary presentation of a second scenario resulting from an animated game spin in accordance with one of more embodiments.

FIG. 6 is an exemplary presentation of a third scenario resulting from an animated game spin in accordance with one of more embodiments.

FIG. 7 is an exemplary presentation of a fourth scenario resulting from an animated game spin in accordance with one of more embodiments.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

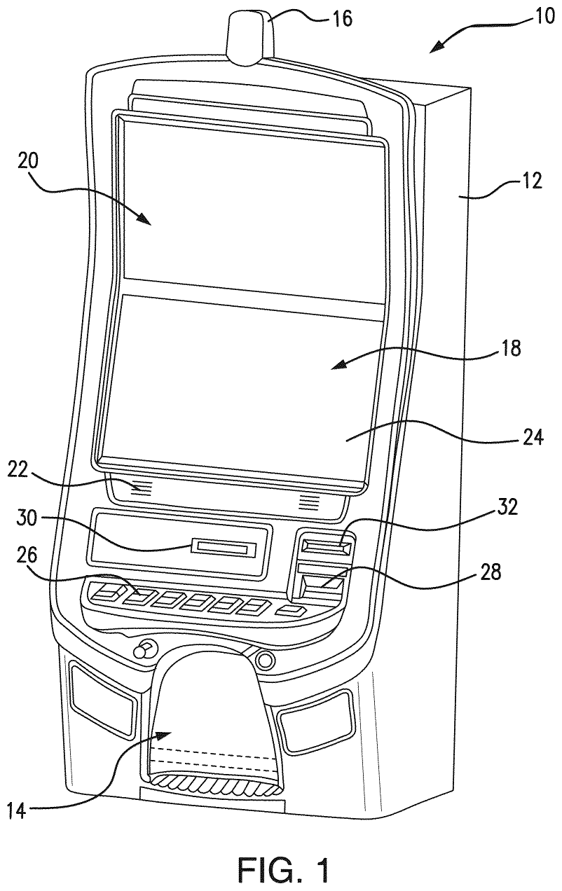

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls, and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices, which together provide a graphical user interface, are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

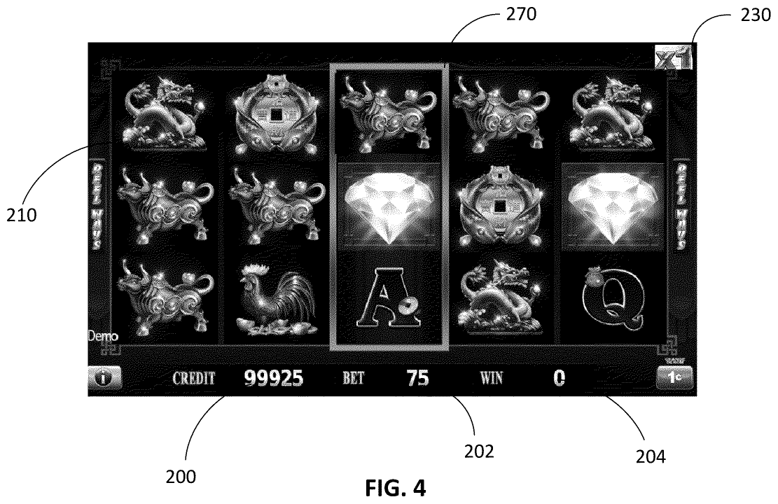

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIG. 4). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 200 (see FIG. 4), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

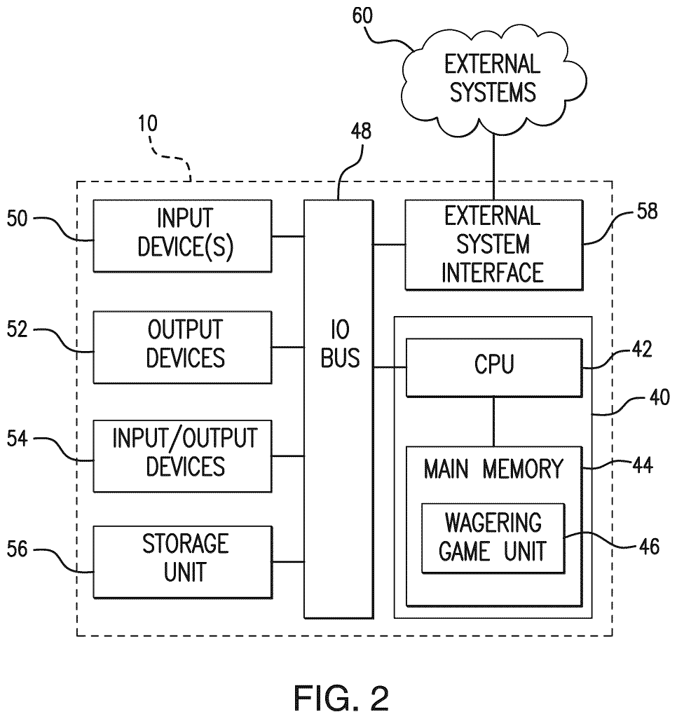

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accordance with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be regulatorily approved and thus implemented with hardware and software architectures, circuitry, and other special features that differentiate it from general-purpose computers (e.g., desktop PCs, laptops, and tablets).

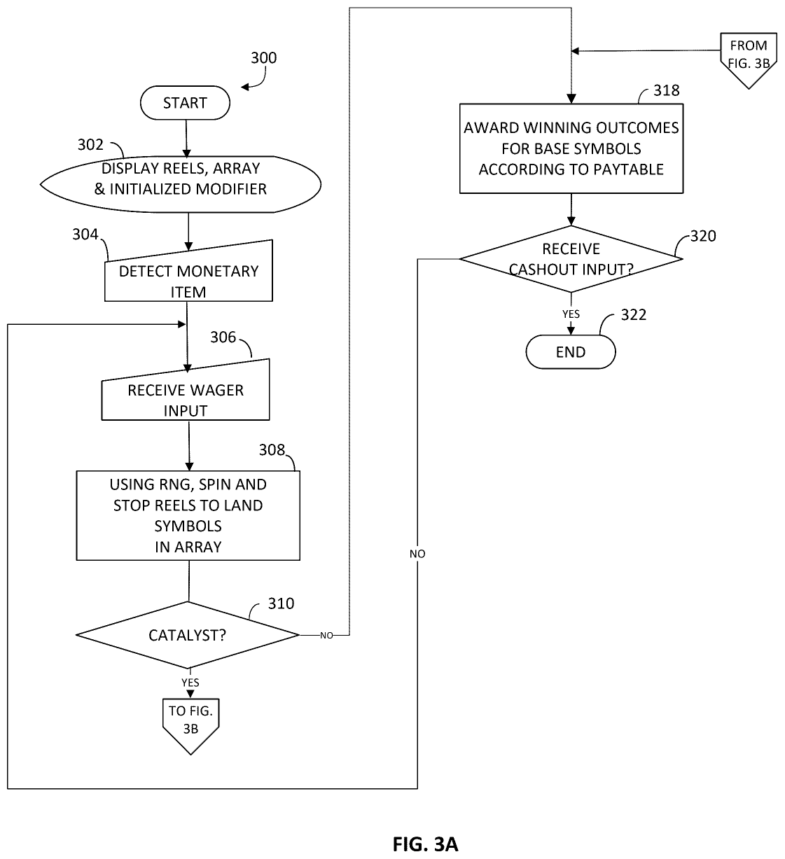

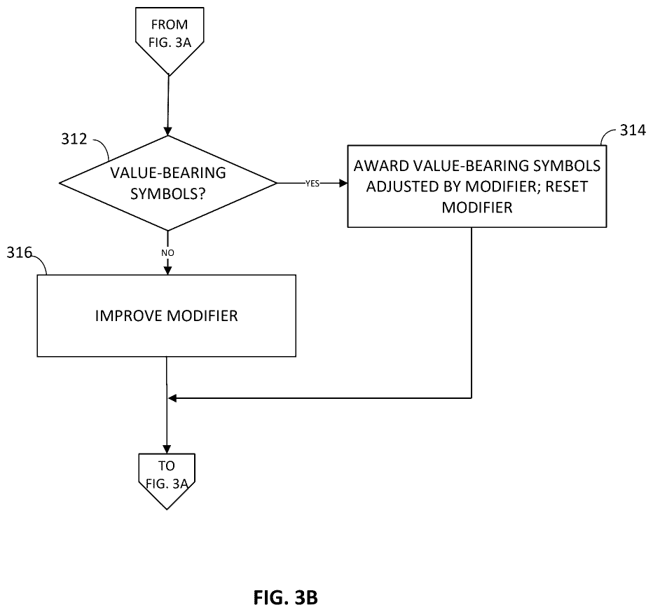

Referring now to FIGS. 3A-3B, there is shown a flow diagram representing one data processing method corresponding to at least some instructions stored and executed by the game-logic circuitry 40 in FIG. 2 to perform operations according to an embodiment of the present invention. The data processing method is described below in connection with the exemplary presentations of four different spin outcome scenarios in FIGS. 4-7.

Referring to FIG. 3A and common to all of the four scenarios, the data processing method commences at step 300. At step 302, the game-logic circuitry controls one or more presentation devices (e.g., a video display device) of the graphical user interface to present a plurality of symbol-bearing reels, an array 210 and a modifier 230 (FIG. 4). Although the method is described with respect to one presentation device, it is to be understood that the presentation described herein may be performed by a presentation assembly including more than one presentation device. The symbol positions of the array may be arranged in a variety of configurations, formats, or structures and may comprise a plurality of rows and columns. The rows of the array are oriented in a generally horizontal direction, and the columns of the array are oriented in a generally vertical direction. The symbol positions in each row of the array are horizontally aligned with each other, and the symbol positions in each column of the array are vertically aligned with each other. Alternatively, the symbol positions may be arranged in a honeycomb configuration with adjacent columns vertically offset from each other by one-half symbol position or adjacent rows horizontally offset from each other by one-half symbol position. The number of symbol positions in different rows and/or different columns may vary from each other. The reels may be associated with the respective columns of the array such that the reels spin vertically, and each reel populates a respective column. In another embodiment, the reels may be associated with the respective rows of the array such that the reels spin horizontally, and each reel populates a respective row. In some embodiments, the reels are associated with respective individual symbol positions of the array such that each reel animates in place and populates only its respective symbol position. The symbol array configuration may vary between the base game and any bonus games utilizing the array.

### Game Play Initiation

Referring to FIGS. 4-7, the symbol array 210 has a three-by-five rectangular configuration, and the reels are associated with the respective columns of the array 210 such that the reels spin vertically, and each reel populates a respective column. Referring to FIG. 4, the reels bear a plurality of symbols that may, for example, include various base symbols 9, 10, J, Q, K, A or other symbols with various depictions such as Coins, Dragons, Bulls, Roosters, Diamonds, etc.

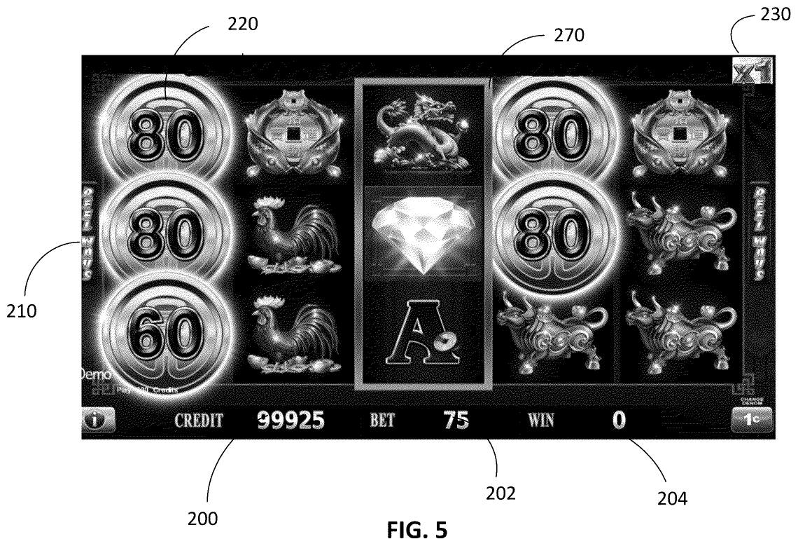

Referring to FIG. 5, the plurality of symbols also include value-bearing symbols 220, otherwise known as WYSIWYG (“What You See is What You Get”) or “cash on reels” symbols. Each value-bearing symbol is associated with a credit or currency value indicated on the symbol itself. The value on a particular credit-bearing symbol may be fixed or variable (e.g., random) from one game cycle to the next. Different value-bearing symbols on the reels may have different values. In one or more embodiments, a value-bearing symbol may be associated with a value determined or displayed separately. For example, rather than a specific amount, a MINI, MINOR, MAJOR or GRAND award label associated with a progressive or non-progressive jackpot may be indicated on a value-bearing symbol.

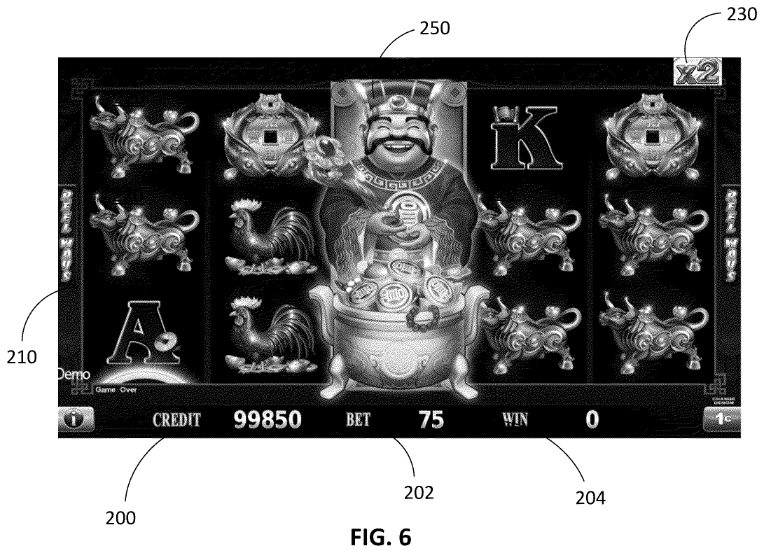

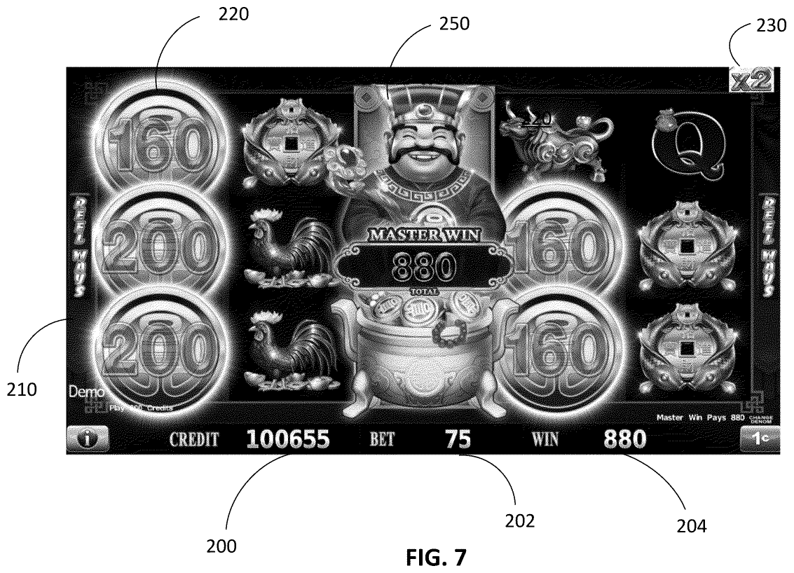

The plurality of symbols also include a catalyst symbol 250 (FIGS. 6-7), which, when landed in the array, may trigger specific actions, as will be described below. In FIGS. 4-7, the center column is highlighted with a rectangle to draw attention to a demarcated area catalyst symbol area 270.

At step 304, the game-logic circuitry detects, via a value input device, a physical item associated with a monetary value that establishes a monetary balance in the form of cash or credits. The monetary balance may be shown on a meter 200 (FIGS. 4-7).

### Common Game Spin in Response to a Wager

At step 306, the game-logic circuitry initiates a base wagering game cycle (i.e., spin cycle) in response to an input indicative of a wager covered by the monetary balance. To initiate a spin of the reels, the player may press a “Spin” or “Max Bet” key on a button panel or touch screen. The wager may be shown on a bet meter 202 (FIGS. 4-7).

At step 308, using an RNG, the game-logic circuitry spins and stops the reels to randomly land symbols from the reels in the array in visual association with one or more (lines, ways, patterns, or arrangements. As noted above, the reels may be associated with the respective columns of the array such that the reels spin vertically, and each reel populates a respective column. The reel spin may be animated on a video display of the graphical user interface by depicting three-symbol high symbol-bearing strips moving vertically across the display and synchronously updating the symbols visible at each location in the array as the strip moves across the display. Once stopped, each reel may or may not “nudge,” that is, advance one or more reel symbol positions in either direction before coming to a final stop.

The landed symbols displayed by the graphical user interface in FIGS. 4-7 represent four possible scenarios, each with its own continuing path through the data processing method. Each scenario, and its respective path, are individually described below.

### Scenario 1—No Catalyst Symbol

FIG. 4 is an exemplary presentation of a first scenario resulting from an exemplary animated game spin in accordance with one of more embodiments and may referred to while also referring to FIG. 3A.

In FIG. 4, the array 210 is shown fully populated with its landed symbols. At step 310, since a catalyst symbol 250 is not present in the array 210, flow proceeds directly to step 318.

At step 318, the game-logic circuitry evaluates the patterns of landed base symbols in the array 210. Payouts are awarded in accordance with a pay table. The pay table, for example, may be limited to, or may combine, “line pays,” “ways pays” and “scatter pays.” Line pays occur when a predetermined type and number of symbols appear along an activated payline, typically in a particular order such as left to right, right to left, top to bottom, bottom to top, etc. Ways pays appear on adjacent reels without the requirement to be on a specified pay line or directly adjacent to one another. Scatter pays occur when a predetermined type and number of symbols appear anywhere in the displayed array without regard to position or paylines. Each payline preferably consists of a single symbol position in each column of the array. The number of paylines may be as few as one or as many as possible given each payline consists of a single symbol position in each column of the array. To animate a pay, the display may apply a border, pattern, color change, background change, watermark, or other distinguishing characteristic to the winning payline and/or winning symbols that contributed to the pay. The awarded pays are added to a win meter 204 (FIGS. 4-7).

In the embodiments described here, winning combinations are evaluated as “ways pays”, in which like symbols in winning combinations appear on adjacent reels without the requirement to be on a specified pay line or directly adjacent to one another. As described above, this is in contrast to pay line combinations in which like symbols must align along one or more pay lines running from left to right across the columns.

In the example shown in FIG. 4, the three by five array has 243 (35) ways to win. In a 243 ways slot machine, any combination of three or more matching symbols can be a win, provided they appear anywhere in adjacent columns, starting from the first column and going left to right. Only one instance of a symbol in a column is included in a winning combination. This is in contrast to scatter pays, in which all symbols, regardless of how many appear in a column, contribute to a winning combination. Thus, the best combination is a five of a kind. In the example of FIG. 4, there are two winning combinations. The first winning combination illustrated is a “4 Bull Win” including the Bull symbol in the middle row of the first column of the array 210 combined with the Bull symbols in the second, third and fourth columns of the array 210. The second winning combination illustrated is a “4 Bull Win” including the Bull symbol in the bottom row of the first column combined with the Bull symbols in the second, third and fourth columns of the array 210.

Flow then proceeds to step 320, common to each of the four scenarios and described below following the description of Scenario 4.

### Scenario 2-Landed Value-Bearing Symbol(s); No Landed Catalyst Symbol

FIG. 5 is an exemplary presentation of a second scenario resulting from an exemplary animated game spin in accordance with one of more embodiments and may referred to while also referring to FIG. 3A.

At step 310, since a catalyst symbol 250 is not present in the array 210, as in Scenario 1, flow proceeds directly to step 318.

At step 318, the game-logic circuitry evaluates the patterns of landed base symbols in the array 210 as above. As will be shown in the discussion of scenario 4, the values borne by value-bearing symbols are collected and added to the win meter 204 only if a catalyst symbol 250 is present in the array. In scenario 2, the value-bearing symbols 220 instead serve as “blockers,” because they cannot contribute to a winning award and occupy space that may otherwise be occupied by a base symbol. Thus, the number of possible base symbol winning combinations is reduced. Nonetheless, at step 318, any base symbol payouts are awarded in accordance with the pay table as described above.

Flow then proceeds to step 320, common to each of the four scenarios and described below following the description of Scenario 4.

Scenario 3-Landed Catalyst Symbol with No Landed Value-Bearing Symbol(s)

FIG. 6 is an exemplary presentation of a third scenario resulting from an exemplary animated game spin in accordance with one of more embodiments and may referred to while also referring to FIGS. 3A-3B.

At step 310, a catalyst symbol 250 is found present in the array 210. In FIGS. 6-7, the catalyst symbol 250 is illustrated as a “stacked symbol” occupying the entire center column of the array 210. In the embodiment shown, the catalyst symbol 250 only appears on the center reel. In some embodiments, the catalyst symbol 250 must fully appear in the array 220 as shown in FIG. 6 in order to count as a landed catalyst symbol 250. In other embodiments, if the catalyst symbol 250 only partially appears in the array 210, it may be animated to “nudge” up or down as required to fill the center column of the array 210. Alternately, in cases where the catalyst symbol 250 is only a single-high, non-stacked symbol, it may be animated to expand to fill the entire demarcated area 270, as shown in FIGS. 6-7. In embodiments where each position in the array is associated with an independent reel, when the catalyst symbol 250 lands in the center position of the array 210, it may be animated to expand to fill the entire demarcated area 270. In other embodiments, the catalyst 250 does not expand. While it acts as described above, its “blocking” effects are reduced because base symbols may still land in the other positions of the center column of the array 210 so that longer, more lucrative base symbol combinations, while reduced, are not eliminated.

Because a catalyst symbol is present in the array 210 at step 310, flow proceeds to step 312 of FIG. 3B. At step 312, it is determined that no value-bearing symbols 220 landed in the array 210. In this case, the modifier 230 is improved at step 316. For example, the modifier 230 may be a 1× multiplier, as shown in FIGS. 4-7, and may be improved from a 1× multiplier to a 2× multiplier, as shown in FIGS. 6-7. The multiplier need not simply increment. For example, it may double upon each subsequent improvement or increase by a predetermined fixed or random amount when it is improved. Other types of modifiers are possible in alternate embodiments. For example, the modifier may be a value added to each value-bearing symbol and its improvement may be that the modifier's value is increased by a predetermined fixed amount or a random amount when it is improved.

Once the modifier 230 has been improved at step 316, flow returns to step 318 of FIG. 3A. As described above, the game-logic circuitry evaluates the patterns of landed base symbols in the array 210. A difference between scenario 3 and scenario 1 is that, because the landed catalyst symbol 250 occupies the entire center column of the array, the catalyst symbol 250 serves as a “blocker,” because there can be no left-to-right winning combinations of more than two base symbols. Thus, the number of possible base symbol winning combinations is reduced. Nonetheless, any base symbol payouts are awarded in accordance with the pay table at step 318.

Flow then proceeds to step 320, common to each of the four scenarios and described below following the description of Scenario 4.

### Scenario 4-Landed Catalyst Symbol and Landed Value-Bearing Symbol(s)

FIG. 7 is an exemplary presentation of a fourth scenario resulting from an exemplary animated game spin in accordance with one of more embodiments and may referred to while also referring to FIGS. 3A-3B.

At step 310, a catalyst symbol 250 is found present in the array 210 and flow proceeds to step 312 of FIG. 3B.

In this scenario, at step 312, it is determined that value-bearing symbols 220 also landed in the array 210. Flow, thus, proceeds to step 314, where the modifier 230 is applied to each value shown on the value-bearing symbols. For example, the modifier 230 may be a multiplier, as shown in FIGS. 4-7, and may improve from a 1× multiplier, as shown in FIGS. 4-5, to a 2× multiplier, as shown in FIGS. 6-7. Since the modifier 230 is illustrated as a 2× multiplier, the values on the value-bearing symbols are doubled. The application of the modifier 230 to the value-bearing symbols may be animated. For example, the value-bearing symbols may appear to flash or grow in size as their respective values are increased. The sum of the newly-increased values borne by the value-bearing symbols is then awarded. The awarded pays are added to a win meter 204 (FIGS. 4-7).

Once the modifier 230 has been applied at step 314, it is set to a reset value. For example, a 2× multiplier may be reset to a 1× multiplier or an value adder-type modifier may be reset to a predetermined initial value. Flow then returns to step 318 of FIG. 3A.

As described above in the discussion of scenario 1, the game-logic circuitry evaluates the patterns of landed base symbols in the array 210 at step 318. The difference between scenario 3 and scenario 1 is that, because the landed catalyst symbol 250 occupies the entire center column of the array, the catalyst symbol 250 serves as a “blocker,” limiting the length of left-to-right winning combinations of base symbols to two. Thus, the number of possible base symbol winning combinations is reduced. Nonetheless, any base symbol payouts are awarded in accordance with the pay table at step 318.

### Common Spin Conclusion for All Scenarios

At step 320, the game-logic circuitry determines whether or not it has received a cashout input via at least one of the one or more player input devices of the gaming machine. If it has not received a cashout input, the game-logic circuitry waits for the next wager input at step 306. If it has received a cashout input, the game-logic circuitry initiates a payout from the monetary balance on the meter 200. The data processing method then ends at step 322.

### ALTERNATE EMBODIMENTS

The illustrated animation sequences resulting from four representative spins are not intended to show all of the frames of the animations or all possible animations, only to highlight various aspects of exemplar animations.

While the above scenarios have been illustrated in the context of a base game, they may be equally applied to a bonus game initiated as a result of a triggering event in the base game as well. For example, more than a predetermined number of value-bearing symbols appearing in the array 210 may initiate a certain number of free spins in which the above described scenarios apply. In these embodiments, the above-described scenarios may apply only to the bonus game. For example, value-bearing symbols 220 and catalyst symbols 230 may not be present on the reels in the base game, which would only pay for winning combinations of base symbols according to the paytable.

In this description, numerous specific details are set forth. However, it is understood that embodiments of the invention may be practiced without these specific details.

The recitations of a value input device for establishing a credit balance, an input device for accepting a wager input that initiates a spin, and a value output device for paying out the credit balance are integrally incorporated within the steps of the data processing method. For example, the presentation of game outcomes through the spinning and stopping of the reels is essential to the game outcome determinations, which may only be initiated by the accepted wager input. Furthermore, a value input device for establishing a credit balance, an input device for accepting a wager that initiates a spin, and a value output device for paying out the credit balance are physical, structural elements that are not shared by generic or well-known computing devices but, rather, are particular to gaming machines.

Embodiments of the present invention realize benefits in increased computer processing efficiency with minimized processing overhead, fewer rules to be evaluated, fewer player inputs to be monitored, and simpler graphical representations. Some embodiments of the present invention comprise an innovative application of data processing steps that, when implemented by game-logic circuitry, direct the presentation assembly of the graphical user interface to present a process that minimizes processing overhead by utilizing numbered indicia to represent credit values instead of complex, fanciful game images. In this way, the value-bearing symbols require fewer rules needed for the award process than would be necessary for calculating values of winning symbol combinations enumerated in stored paytables, as described with respect to the base symbol paytable of step 318 above. Thus, the employment of value-bearing symbols allows for the use of an abbreviated paytable, since some of the pays do not require use of a paytable at all. At the same time, embodiments of the present invention provide a straightforward, what-you-see-is-what-you-get (WYSIWYG) visual presentation that is simple to understand and, therefore, effective in generating player excitement and enthusiasm. The result is a highly flexible value-award process that can be easily adapted to any theme/brand while remaining easily understood by players.

In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method of operating a gaming machine, the method comprising the operations of:
presenting, by a presentation assembly of a graphical user interface, a modifier, an array and a plurality of symbol-bearing reels, the symbols comprising base symbols, value-bearing symbols and a catalyst symbol, the modifier initialized to a predetermined reset value by game-logic circuitry;
animating, via the presentation assembly, a spin of the reels to land symbols from the reels in the array;
animating, via the presentation assembly, winning combinations of the base symbols according to a paytable;
in response to the landed symbols including the catalyst symbol and no value-bearing symbols:
animating, via the presentation assembly, an improvement to the modifier; and
in response to the landed symbols including the catalyst symbol and value-bearing symbols:
animating, via the presentation assembly, application of the improved modifier to the values borne by the value-bearing symbols, awarding the sum of the newly-improved values, and
resetting the modifier to the predetermined reset value.

2. The method of claim 1, wherein each of the plurality of symbol-bearing reels is associated with a respective column in the array.

3. The method of claim 1, further comprising, in response to the landed symbols including the catalyst symbol, animating, via the presentation assembly, expansion of the catalyst symbol to fill a demarcated area of the array.

4. The method of claim 1, wherein the modifier comprises a multiplier.

5. The method of claim 1, wherein the modifier comprises an adder.

6. The method of claim 1, wherein the improvement to the modifier comprises applying a predetermined fixed amount to the modifier.

7. The method of claim 1, wherein the improvement to the modifier comprises applying a randomly-determined amount to the modifier.

8. The method of claim 1, wherein the paytable comprises ways pays.

9. The method of claim 1, wherein the paytable comprises line pays.

10. The method of claim 1, wherein the paytable comprises scatter pays.

11. The method of claim 1, wherein the animated presentation of the spin of the reels is initiated in response to a wager.

12. The method of claim 1, wherein the animated presentation of the spin of the reels is part of a bonus game.

13. The method of claim 1, wherein the value-bearing symbols bear credit amounts.

14. The method of claim 1, wherein the value-bearing symbols bear identification of an associated jackpot.

15. A gaming machine comprising:
a graphical user interface comprising a presentation assembly; and
game-logic circuitry configured to perform the operations of:
presenting, by the presentation assembly, a modifier, an array and a plurality of symbol-bearing reels, the symbols comprising base symbols, value-bearing symbols and catalyst symbols, the modifier initialized to a predetermined reset value by the game-logic circuitry;
animating, via the presentation assembly, a spin of the reels to land symbols from the reels in the array;
animating, via the presentation assembly, winning combinations of the base symbols according to a paytable;
in response to the landed symbols including a catalyst symbol and no value-bearing symbols:
animating, via the presentation assembly, an improvement to the modifier; and
in response to the landed symbols including a catalyst symbol and value-bearing symbols:
animating, via the presentation assembly, application of the improved modifier to the values borne by the value-bearing symbols; and
resetting, by the game-logic circuitry, the modifier to the predetermined reset value.

16. The gaming machine of claim 15, wherein each of the plurality of symbol-bearing reels is associated with a respective column in the array.

17. The gaming machine of claim 15, wherein the modifier comprises a multiplier.

18. The gaming machine of claim 15, wherein the improvement to the modifier comprises applying a predetermined fixed amount to the modifier.

19. The gaming machine of claim 15, wherein the paytable comprises ways pays.

20. The gaming machine of claim 15, wherein the animated presentation of the spin of the reels is initiated in response to a wager.
